(19) United States
(12) Patent Application Publication
(10) Pub. No.: US 2017/0344172 A1
(43) Pub. Date: Nov. 30, 2017

(54) INTERFACE CONTROL METHOD AND MOBILE TERMINAL

(71) Applicants: NANNING FUGUI PRECISION INDUSTRIAL CO., LTD., Nanning (CN); HON HAI PRECISION INDUSTRY CO., LTD., New Taipei (TW)

(72) Inventor: GUAN-FU LI, New Taipei (TW)

(21) Appl. No.: 15/168,107

(22) Filed: May 30, 2016

(51) Int. Cl. G06F 3/041; G06F 3/0354; G06F 3/0481

(52) U.S. Cl. CPC G06F 3/0416; G06F 3/04817; G06F 3/03545; G06F 2203/04106

(57) ABSTRACT

An interface control method applied in a mobile terminal with large screen generates different auxiliary interfaces corresponding to different operation situations when the mobile terminal detects a palm touch event and a stylus touch event simultaneously. Singlehanded operations on the mobile terminal with large screen are then possible with more efficient and convenient usage.

### FIELD

The subject matter herein generally relates to user interface.

### BACKGROUND

The screen size of a smart device is become larger and larger for games, video controls, visions and so on.

A smart device with a large screen brings people superior experiences but also results in some tradeoffs. For example, application icons of installed applications and tool icons of an application are arranged in a traditional way on the large screen. Further, when the smart device is used, some of the application icons on the screen are covered by a hand of the user. Conversely, the tool icons of the application are far from the hand of the user.

Thus, it is important for users to provide a more convenient method for providing access to the controls to the smart device.

### BRIEF DESCRIPTION OF THE DRAWINGS

Implementations of the present technology will be described, by way of example only, with reference to the attached figures, wherein:

FIG. 1 illustrates a block view of an embodiment of function modules of a mobile terminal;

FIG. 2 illustrates an embodiment of an interface control method;

FIG. 3 illustrates another embodiment of an interface control method;

FIG. 4 illustrates another embodiment of an interface control method;

FIG. 5 illustrates an embodiment of a function button and an auxiliary interface generated in one usage scenario; and

FIG. 6 illustrates a diagrammatic view of an embodiment of a function button and an auxiliary interface generated in another usage scenario.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

It should be noted that references to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

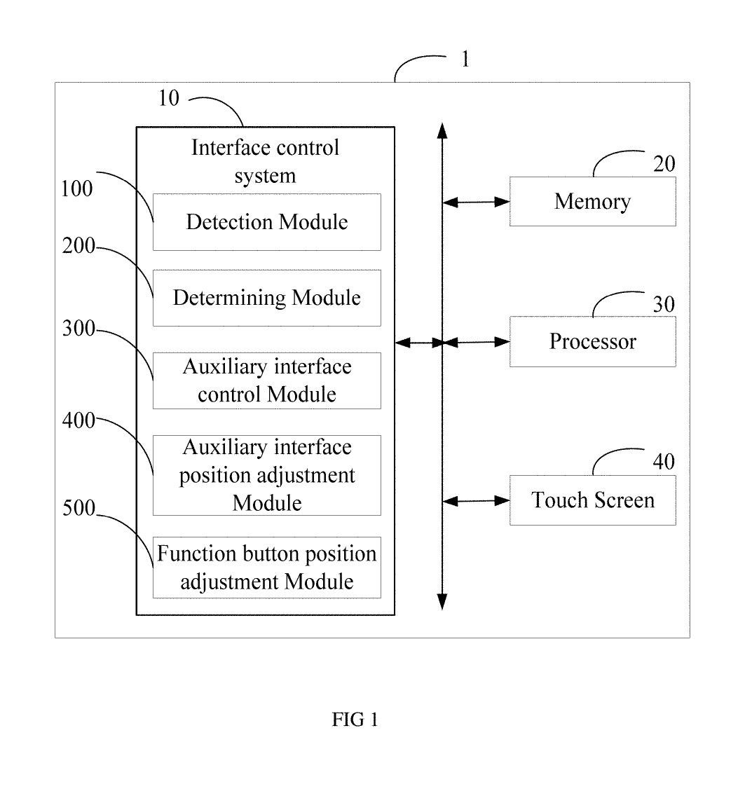

FIG. 1 illustrates function modules of a mobile terminal 1. The mobile terminal 1 may be, for example, a mobile phone, a tablet computer or a personal digital assistant, or the like. The mobile terminal 1 comprises an interface control system 10, a memory 20, at least one processor 30, and a touch screen 40. The touch screen 40 is utilized for not only displaying but also receiving external input from a user, such as touch input. The interface control system 10 controls the interface operations on the mobile terminal 1 in response to touch inputs. Interface or display interface can mean window, display window, region, or display area.

The interface control system 10 comprises a detection module 100, a determining module 200, an auxiliary interface control module 300, an auxiliary interface position adjustment module 400, and a function button position adjustment module 500. The module 100˜500 are configured to be executed by one or more processors (for example the embodiment of the processor 30) to achieve functionality. The memory 20 can store code and data as to the interface control system 10.

The detection module 100 detects a first touch event received by the mobile terminal 1. In this embodiment, the mobile terminal 1 detects touch operations on the touch screen 40 (which may be such as capacitive touch screen, resistive touch screen, or infrared inductive touch screen) through heat or pressure detected, infrared, and other types of sensor devices. The touch operations on a touch screen are those made by human skin or the stylus pen and a touch operation is called a touch event. The detection module 100 detects the first touch event on the touch screen 40 with preset or default frequency.

The determining module 200 determines whether the first touch event comprises a touch from a human palm (palm touch event) and a touch from a stylus pen (stylus touch event). In this embodiment, the determining module 200 determines whether a single first touch event comprises the palm touch event and the stylus touch event simultaneously. The determining module 200 may analyze shape of touched area, size of touched area, pressure, and other parameters of a touch area on the touch screen 40. The determining module 200 may determine whether the first touch event comprises the palm touch event and the stylus touch event based one or more these parameters.

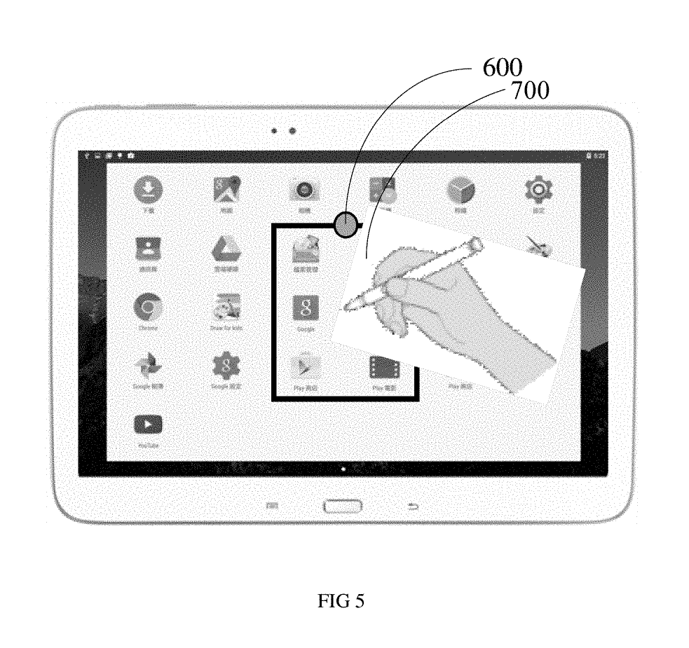

The auxiliary interface control module 300 generates the auxiliary interface 700 when the first touch event comprises the palm touch event and the stylus touch event. In one embodiment, the shape of the auxiliary interface 700 may be a rectangle, as shown in FIG. 5. In another embodiment, the shape of the auxiliary interface 700 may be an arc belt, wherein the touch point of the stylus pen on the mobile terminal 1 indicates an arc center of the arc belt. The arc belt of the auxiliary interface 700 is more adapted to some application situations, such as a drawing application. The shape of the auxiliary interface 700 may be, for example, round, oval, a geometric block or line, and others.

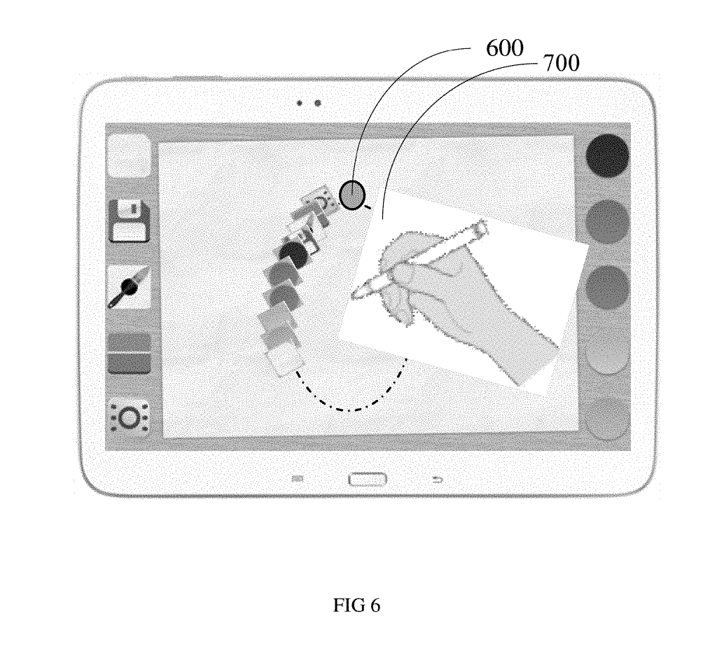

In an embodiment, the auxiliary interface 700 displays touch icons in a first area on a current operation page of the mobile terminal 1. The first area is a region covered by a palm regarding to the palm touch event. When the mobile terminal 1 detects that the palm of user is covering an area of the touch screen 40, such as the first area, all touch icons (such as application startup icons) in that area are invalid or locked. The invalid or locked state indicates a state where icons or individual icon cannot be triggered by the palm touch. The touch icons in the auxiliary interface 700 may be changed with the change of the first area. In another embodiment, the auxiliary interface 700 can also display touch icons in a second area on the current operation page. The second area is a region displaying multiple tool icons show in a current application operation page. As show in FIG. 6, by copying tool icons that in region of displaying tool icons of toolbar or setting hyperlinks to the auxiliary interface 700 to improve use efficiency of tools. FIG. 6 is an example and not a limitation of the disclosure.

The position of the auxiliary interface 700 on the touch screen 40 can be adjusted according to the change of a gesture motion of user. Parameters detected by mobile terminal include a track of movement, a direction of movement, a distance of movement and a speed of movement for example. Those parameters are used to determine the change of the gesture motion. The mobile terminal 1 also comprises the auxiliary interface position adjustment module 400 which detects and predicts the gesture motion, and moves the auxiliary interface 700 to a corresponding position in response to the determined gesture motion. For example, the auxiliary interface position adjustment module 400 detects and predicts the direction and the distance of the gesture motion of user according to two consecutive palm touch events to move the auxiliary interface 700 to a corresponding position. In another embodiment, the position of the auxiliary interface 700 on the touch screen 40 can also be adjusted according to a position of touch point of the stylus pen.

In an embodiment, the auxiliary interface control module 300 can also create at least one function button 600 and display it on the current operation page when the determining module 200 determines that the first touch event comprises the palm touch event and stylus touch event. The function button 600 is shown in FIG. 5 and FIG. 6. The auxiliary interface control module 300 can also detect a second touch event in an area where the function button is located, and activate the auxiliary interface 700 when the second touch event is detected.

In another embodiment, the mobile terminal 1 also comprises the function button position adjustment module 500 for improving use efficiency of the function button 600. The function button position adjustment module 500 analyzes current position of a touch point of the stylus pen on the mobile terminal 1, and adjusts a current position of function button 600 on the current operation page according to the current position of the touch point. In the embodiment, the function button position adjustment module 500 determines values of coordinate of the touch point of stylus pen on the mobile terminal 1 by detecting pressure, touch area, or other parameters on touch screen 40. The function button position adjustment module 500 also calculates coordinate values of function button 600 on the current operation page according to preset positions relationship between the function button 600 and the touch point of stylus pen. Specifically, the function button position adjustment module 500 analyzes the moving direction and the moving distance of the touch point of stylus pen when the touch point of stylus pen is moving. The function button position adjustment module 500 also generates the movement track of the function button 600 according to the moving direction, the moving distance, and the preset position relationship, and moves the function button 600 to a corresponding position according to the movement track.

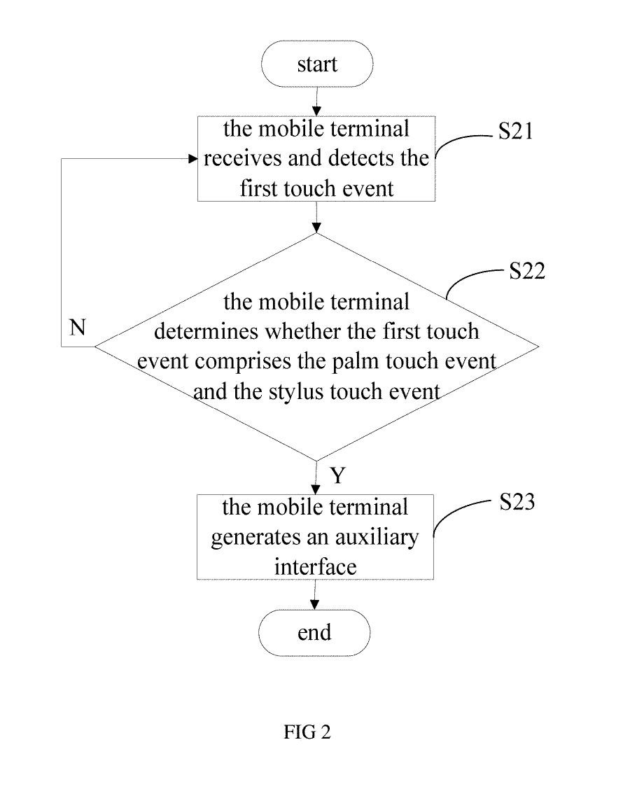

FIG. 2 illustrates an embodiment of an interface control method.

At block 21, the mobile terminal receives and detects the first touch event on the mobile terminal. In this embodiment, the mobile terminal detects the first touch event on the touch screen with preset or default frequency.

At block 22, the mobile terminal determines whether the first touch event comprises the palm touch event and the stylus touch event. In this embodiment, the mobile terminal can analyze a shape of touch, an area of touch, a pressure and other parameters of a touch area on the touch screen. The mobile terminal can determine whether the first touch event comprises the palm touch event and the stylus touch event based on one or more these parameters.

At block 23, the mobile terminal generates the auxiliary interface when the first touch event does comprise the palm touch event and the stylus touch event.

In an embodiment, the auxiliary interface displays touch icons in the first area on the current operation page. The first area is the region covered by the palm regarding to the palm touch event.

In another embodiment, the auxiliary interface displays touch icons in the second area on the current operation page. The second area is a region displaying multiple tool icons shown in a current application operation page.

In an embodiment, the auxiliary interface is within a convenient touching range of the stylus pen.

In another embodiment, the shape of the auxiliary interface may be a rectangle or an oval, or other shapes. The shape of the auxiliary interface may also be an arc belt, wherein the touch point of the stylus pen on the mobile terminal indicates an arc center of the arc belt.

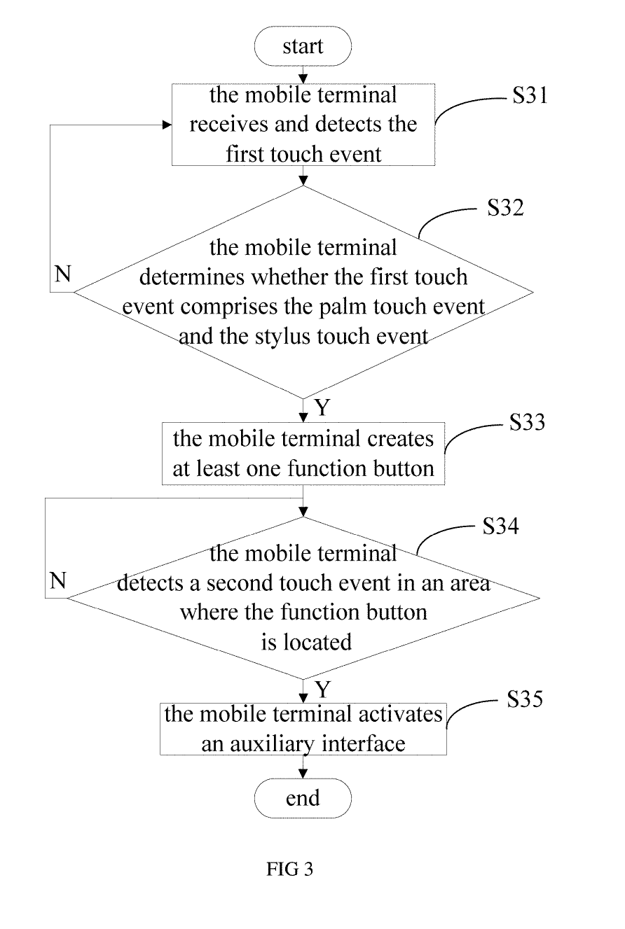

FIG. 3 illustrates an embodiment of an interface control method.

At block 31, the mobile terminal receives and detects the first touch event on the mobile terminal.

At block 32, the mobile terminal determines whether the first touch event comprises the palm touch event and the stylus touch event. When the first touch event comprises the palm touch event and the stylus touch event, method proceeds to block S33. If not, method remains in block S31.

At block 33, the mobile terminal creates at least one function button when the first touch event does comprise the palm touch event and the stylus touch event.

At block 34, the mobile terminal detects the second touch event in an area where the function button is located. When the second touch event is detected, method proceeds to block 35. If not, continues to perform block 34 in default time.

At block 35, the mobile terminal activates the auxiliary interface when the second touch event is detected.

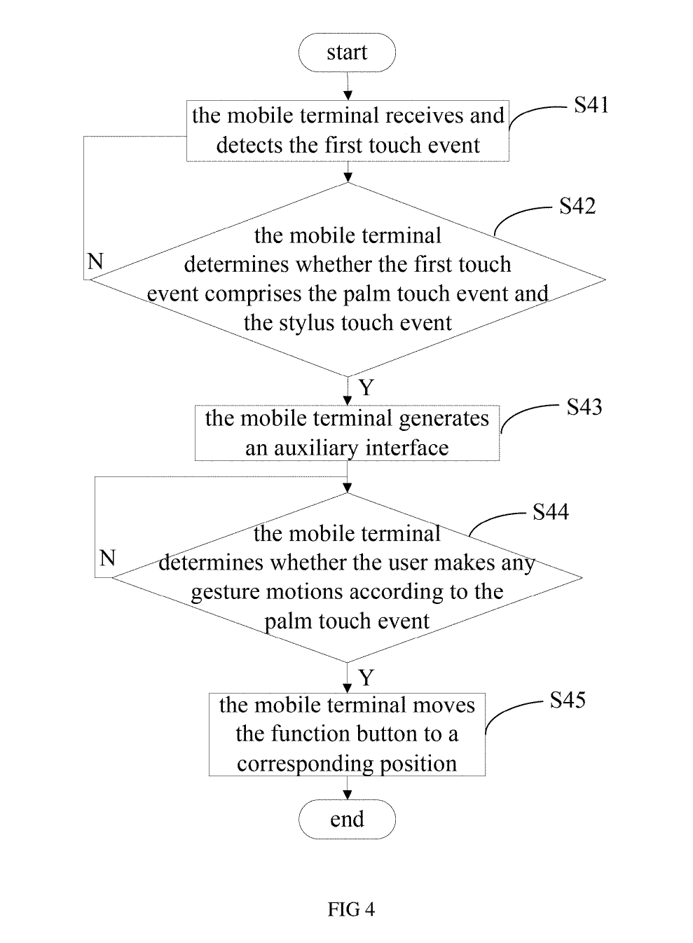

FIG. 4 illustrates another embodiment of an interface control method.

At block 41, the mobile terminal receives and detects the first touch event on the mobile terminal.

At block 42, the mobile terminal determines whether the first touch event comprises the palm touch event and the stylus touch event. When the palm touch event and the stylus touch event are comprised in the first touch event, method proceeds to block 43. If not, method returns to block 41.

At block 43, the mobile terminal generates the auxiliary interface when the first touch event does comprise the palm touch event and the stylus touch event.

At block 44, the mobile terminal determines whether the user makes any gesture motions according to the palm touch event. When there is a gesture motion, method proceeds to block 45. If not, continues to perform block 44.

At block 45, the mobile terminal moves the function button to the corresponding position according to a moving direction and a moving distance when user makes a gesture motion.

The disclosure provides an interface control method and a mobile terminal. The method or the mobile terminal can generate different auxiliary interfaces corresponding to different operation situations when the mobile terminal detects that the first touch event comprises the palm touch event and the stylus touch event simultaneously. The application icons covered by the hand and the tool icons that are traditionally far from the hand can be triggered with touch operation in the auxiliary interface, and user can touch the icons without moving the hand. In this way, singlehanded operations on the mobile terminal with large screen are possible and usage will be more efficient and convenient.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An interface control method executed in a mobile terminal, the method comprising:
receiving and detecting a first touch event;
determining whether the first touch event comprises a palm touch event and a stylus touch event; and
generating an auxiliary interface when the first touch event comprises the palm touch event and the stylus touch event.

2. The method of claim 1, wherein the generating step comprising:
creating at least one function button;
displaying the function button on a current operation page of the mobile terminal;
detecting a second touch event in an area where the function button is located; and
activating the auxiliary interface when the second touch event is detected.

3. The method of claim 2, further comprising:
analyzing a current position of a touch point of the stylus pen on the mobile terminal; and
adjusting a current position of the function button on the current operation page according to the current position of the touch point.

4. The method of claim 1, further comprising:
determining a gesture motion according to the palm touch event; and
moving the auxiliary interface to a corresponding position in response to the determined gesture motion.

5. The method of claim 3, wherein the auxiliary interface is used to display touch icons in a first area on the current operation page, wherein the first area is a region covered by a palm regarding to the palm touch event.

6. The method of claim 3, wherein the auxiliary interface is used to display touch icons in a second area on the current operation page, wherein the second area is a region displaying multiple tool icons shown in a current application operation page.

7. The method of claim 6, wherein the shape of the auxiliary interface is an arc belt, wherein the touch point of the stylus pen on the mobile terminal indicates an arc center of the arc belt.

8. A mobile terminal, which is equipped with a stylus pen, the mobile terminal comprising:
a touch screen configured to display and receive external touch input;
at least one processor;
a non-transitory storage system coupled to the at least one processor and configured to store one or more programs that are to be executed by the at least one processor, the one or more programs comprise instructions for:
receiving and detecting a first touch event;
determining whether the first touch event comprises a palm touch event and a stylus touch event; and
generating an auxiliary interface when the first touch event comprises the palm touch event and the stylus touch event.

9. The mobile terminal of claim 8, wherein the one or more programs further comprise instructions for:
creating at least one function button;
displaying the function button on a current operation page of the mobile terminal;
detecting a second touch event in an area where the function button is located; and
activating the auxiliary interface when the second touch event is detected.

10. The mobile terminal of claim 9, wherein the one or more programs further comprise instructions for:
analyzing a current position of a touch point of the stylus pen on the mobile terminal; and
adjusting a current position of the function button on the current operation page according to the current position of the touch point.

11. The mobile terminal of claim 8, wherein the one or more programs further comprise instructions for:
determining a gesture motion according to the palm touch event; and
moving the auxiliary interface to a corresponding position in response to the determined gesture motion.

12. The mobile terminal of claim 10, wherein the auxiliary interface is used to display touch icons in a first area on the current operation page, wherein the first area is a region covered by a palm regarding to the palm touch event.

13. The mobile terminal of claim 10, wherein the auxiliary interface is used to display touch icons in a second area on the current operation page, wherein the second area is a region displaying multiple tool icons shown in a current application operation page.

14. The mobile terminal of claim 13, wherein the shape of the auxiliary interface is an arc belt, wherein the touch point of the stylus pen on the mobile terminal indicates an arc center of the arc belt.
